(19) United States
(12) Patent Application Publication
(10) Pub. No.: US 2019/0168760 A1
(43) Pub. Date: Jun. 6, 2019

(54) DRIVING STYLE EVALUATION SYSTEM AND METHOD

(71) Applicant: STEERING SOLUTIONS IP HOLDING CORPORATION, Saginaw, MI (US)

(72) Inventors: Patrik M. Ryne, Midland, MI (US); Michael R. Story, Bay City, MI (US); Michelle Greb, Macomb, MI (US); Joachim J. Klesing, Rochester, MI (US); Pierre C. Longuemare, Paris (FR); Ayyoub Rezaeian, Troy, MI (US); Harold Li, Shelby Township, MI (US); Robert E. Llaneras, Pulaski, VA (US)

(21) Appl. No.: 15/829,289

(22) Filed: Dec. 1, 2017

(51) Int. Cl. B60W 30/182; B60W 40/09; B60W 50/08; B60W 50/10; G05D 1/00

(52) U.S. Cl. CPC B60W 30/182; B60W 40/09; G05D 1/0088; B60W 50/10; B60W 50/085

(57) ABSTRACT

A driving style evaluation system includes a processor receiving driving data associated with at least one driving style category during operations performed by a driver during a first driving mode, the processor determining a preferred driving style for each of the at least one driving style categories based on the driving data. Also included is a controller configured to execute commands associated with the preferred driving style during operation of the vehicle in a second driving mode.

### BACKGROUND OF THE INVENTION

The invention relates to autonomous or semi-autonomous vehicles and, more particularly, to systems and methods of evaluating driving styles for use in such vehicles.

Drivers of vehicles each have individual driving styles. For autonomous or semi-autonomous vehicles, more frequent and lengthy periods of driving will be controlled by a robot rather than a human being. The vehicle operator will desirably trust and have confidence in the robot to execute driving tasks safely and in an expected manner. However, a difference in style of robot and human driver may reduce or eliminate operator trust, if the robot does not perform such tasks in a preferred and individualistic manner of the human operator. Consequently, vehicle operators may not want to use various automatic driving features.

### SUMMARY OF THE INVENTION

According to an aspect of the disclosure, a driving style evaluation system includes a processor receiving driving data associated with at least one driving style category during operations performed by a driver during a first driving mode, the processor determining a preferred driving style for each of the at least one driving style categories based on the driving data. Also included is a controller configured to execute commands associated with the preferred driving style during operation of the vehicle in a second driving mode.

According to another aspect of the disclosure, a method of evaluating a driving style is provided. The method includes a recording driving data associated with a driving style category during operation of an autonomous or semi-autonomous vehicle by a driver during a manual driving mode of the vehicle. The method also includes processing the driving data. The method further includes comparing the driving data to a plurality of classifications of the driving style category. The method yet further includes classifying one of the plurality of classifications of the driving style category as a preferred driving style.

According to yet another aspect of the disclosure, a method of evaluating a driving style is provided. The method includes analyzing driver feedback during operation of an autonomous or semi-autonomous vehicle in an autonomous or semi-autonomous driving mode. The method also includes determining a preferred driving style based on the analyzed driver feedback. The method further includes executing commands associated with the preferred driving style during operation of the vehicle in the autonomous or semi-autonomous driving mode.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a vehicle with autonomous or semi-autonomous steering capabilities;

FIG. 2 is a schematic illustration of a driver operating the vehicle in a manual driving mode;

FIG. 3 is a schematic illustration of the vehicle being operated in an autonomous driving mode;

FIG. 4 is a schematic illustration of the driver providing feedback during operation of the vehicle in the autonomous driving mode; and

FIG. 5 is a flow diagram illustrating a method of evaluating a driving style and modifying autonomous driving mode operation of the vehicle.

### DETAILED DESCRIPTION

Referring now to the Figures, where the invention will be described with reference to specific embodiments, without limiting same, illustrated are examples of a system and method associated with evaluation of driving styles and modifying autonomous driving mode operation of an autonomous or semi-autonomous vehicle based on the driving style evaluation. The embodiments described herein provide a vehicle operator with an enhanced sense of comfort since maneuvers performed in an autonomous driving mode of the vehicle are personalized to the driving style of the driver. Such personalization matches the expectations and preferences of the vehicle operator, resulting in the enhanced comfort referenced above.

The embodiments described herein are applicable to autonomous or semi-autonomous vehicles. Autonomous or semi-autonomous vehicles include at least one aspect of driving functionality that is performed automatically with no, or minimal, driver input. Steering, braking and accelerating are examples of driving capabilities that may be carried out autonomously or semi-autonomously when the vehicle is in an autonomous driving mode. When such aspects of driving are commanded by the driver, the vehicle is said to be in a manual driving mode. The autonomous driving mode requires one or more systems in operative communication with vehicle components, such as components associated with steering, braking and accelerating. One such system is referred to as an ADAS. The ADAS includes various components, such as a controller and processor in operative communication with the vehicle components or devices.

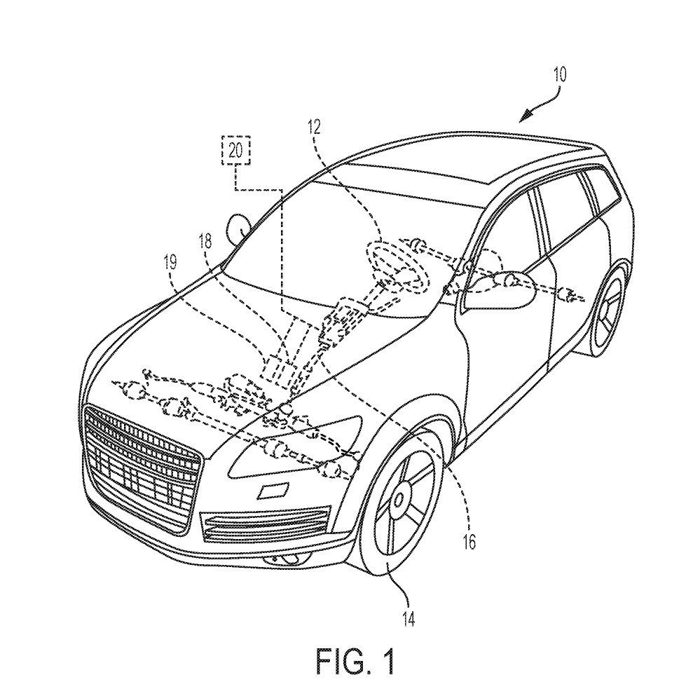

Referring to FIG. 1, an example of an autonomous or semi-autonomous vehicle (referred to hereinafter as an “autonomous vehicle”) is illustrated and generally referenced with numeral 10. The autonomous vehicle 10 includes a steering input device 12, such as a hand wheel, that allows a driver to provide steering commands to road wheels 14 of the vehicle 10. This is done via a steering column 16 and associated components operatively coupled to the road wheels 14. The vehicle 10 also includes a braking device 18 (e.g., brake pedal) and an accelerator 19 (e.g., accelerator pedal) for decelerating and accelerating the vehicle 10. As shown, an ADAS 20 is in operative communication with the steering column 16, the braking device 18 and the accelerator 19.

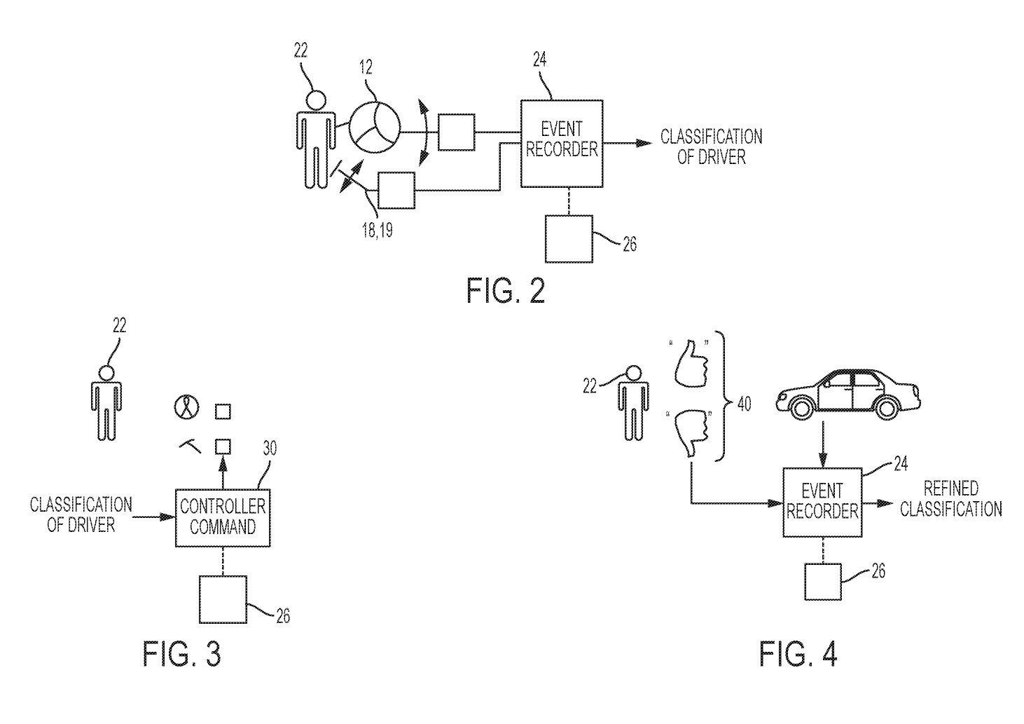

Referring now to FIG. 2, a driver 22 is schematically shown operating the autonomous vehicle 10 in the manual driving mode. As shown, the driver 22 provides manual control of the steering input device 12 and manual control of the braking device 18 and accelerator 19. In performing the manual operations, the driver 22 exhibits tendencies, collectively referred to herein as a style, associated with at least one driving style category. Examples of driving style categories include, but are not limited to, acceleration, deceleration, steering, and following distance.

An event recorder 24 obtains driving data associated with each of the driving style categories. In the case of acceleration and deceleration, the event recorder 24 obtains data relevant to acceleration and braking maneuvers to determine how aggressively or cautiously the driver 22 performs such maneuvers. For steering, the event recorder 24 records data associated with steering operations, such as how a driver changes lanes, performs turns, and proceeds around curves, for example. For following distance, the event recorder 24 records data associated with how closely a driver typically follows behind a vehicle at various speeds of operation.

One or more motion controllers, cameras, sensors, etc. may be utilized with the raw data, and/or to obtain the driving data, to evaluate the data. Evaluation of the driving data involves communicating the data obtained by the event recorder 24, and any other relevant data, to a processor 26. The processor 26 may be integrally formed with the event recorder 24 or may be a separate device in operative communication with the event recorder 24, as shown in FIG. 2. As used herein, the processor refers to processing circuitry that may include an application specific integrated circuit (ASIC), an electronic circuit, an electronic processor (shared, dedicated, or group) and memory that executes one or more software or firmware programs, a combinational logic circuit, and/or other suitable interfaces and components that provide the described functionality.

The processor 26 is programmed with a plurality of classifications for each driving style category. Upon receipt and processing of the driving data, as well as any other relevant data, the processor 26 determines a preferred driving style for each of the driving style categories. In some embodiments, a single preferred driving style is determined for an overall driving style (e.g., aggressive, moderate, conservative). Determination of the preferred driving style may be referred to as a classification of the driver's style in one or more categories, or an overall style.

In some embodiments, the driver's preferred style may be classified in different driving condition categories. For example, a driver may be aggressive in certain weather conditions, while extremely conservative in other weather conditions. In addition to weather conditions, the classification(s) of the preferred driving style may depend on traffic density, driving surface terrain, and pedestrian population, for example.

Referring now to FIG. 3, the autonomous vehicle 10 is schematically shown during operation in the autonomous driving mode. The driver 22 is present, but not providing manual input during operation in the autonomous driving mode, as described in detail above. After the driver's preferred driving style(s) have been determined, or classified, the system operates the autonomous vehicle 10, while in the autonomous driving mode, in a manner that is consistent with the classifications. In particular, a controller 30 executes commands associated with the preferred driving style during operation of the vehicle 10 during operation in the autonomous driving mode. For example, if a driver has been classified as having a preference for a longer following distance when traveling behind another vehicle, the controller 30 will execute commands that cause the vehicle 10 to follow the leading vehicle at a greater distance than a following distance associated with an aggressive driving style. In other words, the overall system, via driver data recordation and data processing with the processor 26, “learns” a driver's driving characteristics that the driver appears to be comfortable with and classifies the driver's preference(s) with one or more categories. The vehicle 10 is then operated in a manner that is consistent with the driver's preferred driving style(s).

Referring now to FIG. 4, the autonomous vehicle 10 is schematically shown during operation in the autonomous driving mode. The driver 22 is present, but not providing manual input during operation in the autonomous driving mode. As described above, the vehicle 10 is operated in the autonomous driving mode in accordance with the determined classification(s). To further refine the classification(s), the event recorder 24 and/or processor 26 records and processes data upon receipt of driver feedback provided during operation of the vehicle 10 in the autonomous driving mode. The driver feedback provided is generically represented with a “thumb-up”, or “like” and a “thumb-down”, or “dislike” and with numeral 40. The driver feedback 40 is provided to further refine the classification(s) that were determined from the driver data obtained during the manual driving mode. The driver feedback 40 provides additional data that the system can “learn” from, thereby optimizing the driving style classification(s).

The driver feedback 40 may be in the form of explicit feedback and/or implicit feedback. Explicit feedback refers to feedback actions that are intentionally and consciously provided by the driver 22. Examples of explicit feedback include, but are not limited to, manually pushing a button, switch or the like, or verbally providing a feedback response. Implicit feedback refers to feedback actions that are unintentionally provided by the driver 22, but observed by the system. For example, a camera may detect facial expressions and/or body movement or language. An audio system may detect excited verbal utterances. The explicit and/or implicit feedback are indicative of certain reactions to driving maneuvers performed while the vehicle 10 is operated in the autonomous driving mode. This allows the system to modify the commands executed by the controller to meet the driver's style preferences.

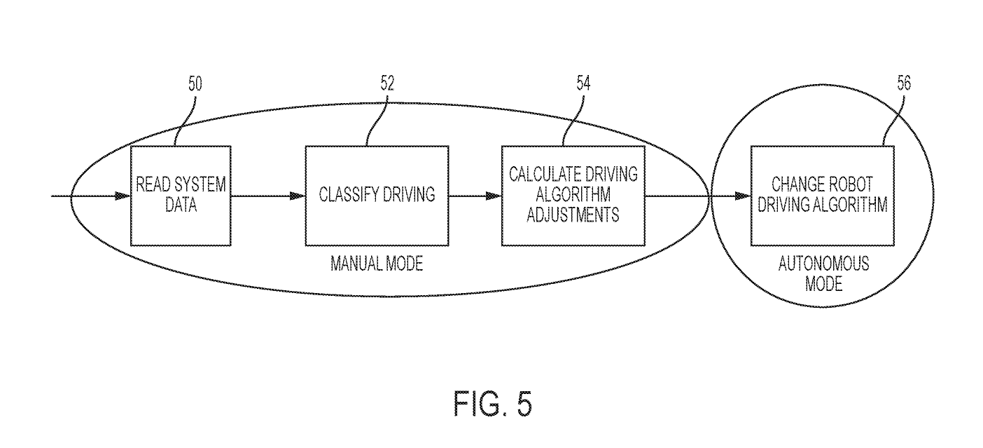

Referring now to FIG. 5, a flow diagram illustrates certain operations of the system and method. As shown, block 50 represents driving data being obtained during maneuvers performed by the driver while the vehicle is in the manual driving mode. Block 52 illustrates driving style classification based on the driving data obtained. Block 54 illustrates driving algorithm adjustments made from default settings to settings associated with the preferred driving style. Block 56 illustrates execution of the algorithm modifications made in the autonomous driving mode.

In the embodiments described above, the system and method are described as having the driving data being obtained prior to collection of data associated with driver feedback. However, it is to be appreciated that the system may modify autonomous driving style based solely on the collection of driver feedback or prior to collection and processing of driver data that is obtained in the manual driving mode.

The embodiments described herein personalize the driving style of the system in the autonomous driving mode based on preferences indicated by the driver. Personalization facilitates an increased level of comfort felt by the driver, thereby enhancing the overall operator trust in the autonomous vehicle.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A driving style evaluation system comprising:
a processor receiving driving data associated with at least one driving style category during operations performed by a driver during a first driving mode, the processor determining a preferred driving style for each of the at least one driving style categories based on the driving data; and
a controller configured to execute commands associated with the preferred driving style during operation of the vehicle in a second driving mode.

2. The driving evaluation system of claim 1, wherein the first driving mode is a manual driving mode of an autonomous or semi-autonomous vehicle and the second driving mode is an autonomous or semi-autonomous driving mode of the vehicle.

3. The driving evaluation system of claim 1, wherein the at least one driving style category is at least one of acceleration, deceleration, steering, and following distance.

4. The driving evaluation system of claim 1, wherein the preferred driving style is determined in a plurality of driving condition categories.

5. The driving evaluation system of claim 4, wherein the plurality of driving condition categories is at least one of weather conditions, traffic density, driving surface terrain, and pedestrian population.

6. A method of evaluating a driving style comprising:
recording driving data associated with a driving style category during operation of an autonomous or semi-autonomous vehicle by a driver during a manual driving mode of the vehicle;
processing the driving data;
comparing the driving data to a plurality of classifications of the driving style category; and
classifying one of the plurality of classifications of the driving style category as a preferred driving style.

7. The method of claim 6, further comprising executing commands associated with the preferred driving style during operation of the vehicle in an autonomous or semi-autonomous driving mode.

8. The method of claim 6, wherein the driving style category is one of a plurality of driving style categories.

9. The method of claim 8, wherein the plurality of driving style categories comprises at least two of acceleration, deceleration, steering, and following distance.

10. The method of claim 7, further comprising analyzing driver feedback during operation of the vehicle in the autonomous or semi-autonomous driving mode.

11. The method of claim 10, wherein the driver feedback is explicit feedback intentionally provided by the driver.

12. The method of claim 10, wherein the driver feedback is implicit feedback unintentionally provided by the driver.

13. The method of claim 12, wherein the implicit feedback comprises analysis of a facial expression.

14. The method of claim 10, wherein the driver feedback is at least one of explicit and implicit feedback provided by the driver.

15. The method of claim 14, further comprising modifying the preferred driving style based on the analysis of the explicit and/or the implicit feedback.

16. A method of evaluating a driving style comprising:
analyzing driver feedback during operation of an autonomous or semi-autonomous vehicle in an autonomous or semi-autonomous driving mode;
determining a preferred driving style based on the analyzed driver feedback; and
executing commands associated with the preferred driving style during operation of the vehicle in the autonomous or semi-autonomous driving mode.

17. The method of claim 16, wherein the driver feedback is explicit feedback intentionally provided by the driver.

18. The method of claim 16, wherein the driver feedback is implicit feedback unintentionally provided by the driver.

19. The method of claim 18, wherein the implicit feedback comprises analysis of a facial expression.

20. The method of claim 16, wherein the driver feedback is a combination of explicit and implicit feedback provided by the driver.
